(19) United States
(12) Patent Application Publication
(10) Pub. No.: US 2026/0287951 A1
(43) Pub. Date: Sep. 24, 2026

(54) DISPLAY SUBSTRATE, DISPLAY PANEL, AND DISPLAY DEVICE

(71) Applicants: Beijing BOE Optoelectronics Technology Co., Ltd., Beijing (CN); BOE Technology Group Co., Ltd., Beijing (CN)

(72) Inventors: Qi DENG, Beijing (CN); Yong ZHANG, Beijing (CN); Zhichao YANG, Beijing (CN); Lingfang NIE, Beijing (CN); Zanwu GUO, Beijing (CN); Desheng WANG, Beijing (CN); Qiuyang ZHANG, Beijing (CN)

(21) Appl. No.: 18/996,056

(22) PCT Filed: May 14, 2024
(86) PCT No.: PCT/CN2024/093225

§ 371 Date: Jan. 17, 2025

(30) Foreign Application Priority Data
Jun. 29, 2023 (CN) 202310786042.1

(51) Int. Cl. G02F 1/1362; G02F 1/1368

(52) U.S. Cl. CPC G02F 1/136286; G02F 1/136204; G02F 1/136254; G02F 1/1368

(57) ABSTRACT

A display substrate, a display panel, and a display device. The display substrate includes: a first base substrate, the first base substrate including: a display region and a peripheral region surrounding the display region, and the peripheral region including a first peripheral region located on one side of the display region in a first direction; first bonding terminals, located in the first peripheral region, the first bonding terminals being configured to bind to a driving chip; and test terminals, in the first peripheral region, the plurality of test terminals and the plurality of first bonding terminals being located on the same side of the first base substrate. The orthographic projection of the plurality of test terminals on the first base substrate is located on the side, distant from the display region, of the orthographic projection of the plurality of first bonding terminals on the first base substrate.

### CROSS-REFERENCE TO RELATED APPLICATIONS

This application is a national phase entry under 35 U.S. C § 371 of International Application No. PCT/CN2024/093225, filed on May 14, 2024, claims priority to Chinese Patent Application No. 202310786042.1, filed on Jun. 29, 2023, in the China National Intellectual Property Administration, with a name “Display substrate, display panel and display device”. The entire disclosure of the above application is incorporated herein by reference.

### TECHNICAL FIELD

The present disclosure relates to the field of display technology, and in particular to a display substrate, a display panel and a display device.

### BACKGROUND

During the production process of display products, before bonding the driving chip and other structures, the manufactured panel needs to be tested by electrical means to detect defects in time to avoid defective products flowing into the later processes and causing waste.

### SUMMARY

An embodiment of the present disclosure provides a display substrate, the display substrate including:
a first base substrate including a display region and a peripheral region surrounding the display region; wherein the peripheral region includes a first peripheral region located at a side of the display region in a first direction;
a plurality of first bonding terminals located in the first peripheral region; wherein the plurality of first bonding terminals are configured to be bonded to a driving chip;
a plurality of test terminals located in the first peripheral region and on a side of the first base substrate same as a side where the plurality of first bonding terminals are located; wherein orthographic projections of the plurality of test terminals on the first base substrate are located on a side of orthographic projections of the plurality of first bonding terminals on the first base substrate facing away from the display region.

In some embodiments, the display substrate further includes:
a plurality of second bonding terminals located in the first peripheral region and on a side of the first base substrate same as the side where the plurality of first bonding terminals are located; wherein the plurality of second bonding terminals are configured to be bonded to a flexible circuit board, and at least part of the second bonding terminals are electrically connected to at least part of the first bonding terminals; orthographic projections of the plurality of second bonding terminals on the first base substrate are located on a side of the orthographic projections of the plurality of first bonding terminals on the first base substrate facing away from the display region, and in a second direction, the orthographic projections of the plurality of test terminals on the first base substrate are located on a side of the orthographic projections of the plurality of second bonding terminals on the first base substrate, and the second direction intersects with the first direction.

In some embodiments, the plurality of first bonding terminals includes:
a plurality of input terminals, wherein at least part of the plurality of input terminals are arranged along the second direction;
the plurality of test terminals are located on a side of the plurality of input terminals facing away from the display region;
the display substrate further includes:
a plurality of test signal lines located in the first peripheral region; each of the plurality of test signal lines is electrically connected to the test terminals; the test signal lines include a first portion, an orthographic projection of the first portion on the first base substrate and orthographic projections of the input terminals on the first base substrate do not overlap with each other, and the orthographic projection of the first portion on the first base substrate overlaps with an orthographic projection of a region between adjacent input terminals on the first base substrate.

In some embodiments, the plurality of first bonding terminals further includes:
a plurality of output terminals located on a side of the plurality of input terminals facing the display region; wherein the test signal lines are electrically connected to the output terminals.

In some embodiments, the plurality of input terminals include a plurality of first input terminals, and a plurality of first dummy terminals located on a side of the plurality of first input terminals in a direction in which the plurality of second bonding terminals point to the plurality of test terminals;
the plurality of first input terminals are electrically connected to at least part of the second bonding terminals;
the orthographic projection of the first portion on the first base substrate does not overlap with an orthographic projection of a region between adjacent first input terminals on the first base substrate, and the orthographic projection of the first portion on the first base substrate overlaps with an orthographic projection of a region between adjacent first dummy terminals on the first base substrate.

In some embodiments, the first portion includes a plurality of first sub-signal lines arranged along the second direction; orthographic projections of the first sub-signal lines on the first base substrate overlap with the orthographic projection of the region between the adjacent first dummy terminals on the first base substrate.

In some embodiments, the test signal lines further include a second portion and a third portion which are respectively connected to two ends of the first portion in an extending direction of the first portion; wherein the second portion is located on a side of the first portion facing the display region, and the third portion is located on a side of the first portion facing away from the display region;
in the second direction, a width of the first sub-signal lines is smaller than a width of a part of the second portion connected with the first portion, and the width of the first sub-signal lines is smaller than a width of a part of the third portion connected with the first portion.

In some embodiments, an edge of at least one of the first sub-signal lines extending in the first direction is located in a straight line same as a straight line where an edge of the second portion extending in the first direction is located, and the edge of at least one of the first sub-signal lines extending in the first direction is located in a straight line same as a straight line where an edge of the third portion extending in the second direction.

In some embodiments, the plurality of test terminals are arranged in sequence along the second direction;
the first portion of the plurality of test signal lines is sequentially arranged along the second direction, the second portion of the plurality of test signal lines is sequentially arranged along the second direction, and the third portion of the plurality of test signal lines is sequentially arranged along the second direction.

In some embodiments, the display substrate further including:
a plurality of transistors located on a side of the first base substrate same as a side where the plurality of first bonding terminals are located in the first peripheral region; wherein orthographic projections of the plurality of transistors on the first base substrate are located between orthographic projections of a plurality of output terminals on the first base substrate and the orthographic projections of the plurality of input terminals on the first base substrate; each of the plurality of transistors includes a control electrode, a first electrode and a second electrode; the plurality of transistors includes: a plurality of first transistors, and a plurality of second transistors located on at least a side of the plurality of first transistors in the second direction;
the plurality of output terminals include a plurality of first output terminals, and a plurality of second output terminals located on at least a side of the plurality of first output terminals in the second direction; first electrodes of the first transistors are electrically connected to the first output terminals, and first electrodes of the second transistors are electrically connected to the second output terminals;
the plurality of test signal lines include a control signal line, a plurality of first signal lines, and at least one second signal line;
the plurality of test terminals includes a control terminal, a plurality of first test terminals, and a second test terminal;
the control terminal is electrically connected to control electrodes of the plurality of transistors through the control signal line; the first test terminals are electrically connected to second electrodes of a part of the first transistors through the first signal lines; and the second test terminal is electrically connected to second electrodes of at least part of the second transistors through the at least one second signal line.

In some embodiments, in the second direction, the control terminal is located on a side of remaining test terminals other than the control terminal facing away from the plurality of second bonding terminals.

In some embodiments, the second test terminal includes at least one sub-test terminal; in the second direction, the at least one sub-test terminal is located between the first test terminals and the control terminal, or the at least one of the sub-test terminals is located on a side of the first test terminals facing away from the control terminal.

In some embodiments, the second test terminal includes: a first category of second test terminal located between the plurality of first test terminals and the control terminal, and a second category of second test terminal located on a side of the plurality of first test terminals facing away from the control terminal;
the plurality of second transistors are divided into a first group located on a side of the plurality of first transistors in a direction in which the plurality of first test terminals point to the first category of second test terminal, and a second group located on a side of the plurality of first transistors in a direction in which the plurality of first test terminals point to the second category of second test terminal;
the plurality of second output terminals are divided into a third group located on a side of the plurality of first output terminals in the direction in which the plurality of first test terminals point to the first category of second test terminal, and a fourth group located on a side of the plurality of first output terminals in a direction in which the plurality of first test terminals point to the second category of second test terminal; the second output terminals in the third group are electrically connected to the second transistors in the first group, and the second output terminals in the fourth group are electrically connected to the second transistors in the second group;
the first category of second test terminal is electrically connected to second electrodes of the first group through the at least one second signal line, and the second category of second test terminal is electrically connected to second electrodes of the second group through the at least one second signal line.

In some embodiments, the test signal lines further include a fourth portion electrically connected to the second portion;
at least part of the fourth portion extends along the second direction, and an orthographic projection of the fourth portion on the first base substrate is located between the orthographic projections of the plurality of output terminals on the first base substrate and the orthographic projections of the plurality of input terminals on the first base substrate;
a fourth portion of the control signal line is electrically connected to the control electrodes of the plurality of transistors, a fourth portion of the first signal lines is electrically connected to second electrodes of the first transistors, and a fourth portion of the at least one second signal line is electrically connected to second electrodes of the second transistors;
the fourth portion of the first signal lines is located on a side of the fourth portion of the control signal line facing away from the display region, and the fourth portion of the at least one second signal line is located on the side of the fourth portion of the control signal line facing away from the display region.

In some embodiments, the second test terminal includes: a first category of second test terminal and a second category of second test terminal;
the at least one second signal line includes: a first category of second signal line and a second category of second signal line;
a fourth portion of the first category of second signal line electrically connected to the first category of second test terminal is located between the fourth portion of the control signal line and the fourth portion of the plurality of first signal lines, and a fourth portion of the second category of second signal line electrically connected to the second category of second test terminal is located on a side of the fourth portion of the plurality of first signal lines facing away from the fourth portion of the control signal line.

In some embodiments, the control signal line further includes a fifth portion, wherein the fifth portion is electrically connected to the fourth portion at an end of the fourth portion facing away from the second portion;
the plurality of first input terminals include a first ground-level signal input terminal; and the fifth portion is electrically connected to the first ground-level signal input terminal.

In some embodiments, the peripheral region further includes second peripheral regions respectively located on both sides of the display region in the second direction; wherein the display substrate further includes:
a plurality of sub-pixel units located on a side of the first base substrate same as the side where the plurality of first bonding terminals are located in the display region; the plurality of sub-pixel units include a plurality of sub-pixel units with different light emission colors; a quantity of the first test signal lines is equal to a quantity of types of the sub-pixel units;
a plurality of scanning lines electrically connected to the plurality of sub-pixel units and extending from the display region to the second peripheral regions; wherein the plurality of scanning lines are arranged along the first direction and extend along the second direction;
a plurality of data lines electrically connected to the plurality of sub-pixel units and extending from the display region to the peripheral regions; wherein the plurality of data lines are arranged along the second direction and extend along the first direction; each of the plurality of data lines is electrically connected to the first output terminals; and
a plurality of first connection leads extending from the first peripheral region to the second peripheral regions; two ends of each of the plurality of first connection leads are electrically connected to the second output terminals and the scanning lines respectively.

In some embodiments, the display substrate further includes: a common electrode, and a common electrode line electrically connected to the common electrode;
the first peripheral region includes a first bonding region and a second bonding region located on a side of the first bonding region facing away from the display region, the orthographic projections of the plurality of first bonding terminals on the first base substrate and the orthographic projections of the plurality of transistors on the first base substrate fall into the first bonding region, and the orthographic projections of the plurality of second bonding terminals on the first base substrate fall into the second bonding region;
in the first peripheral region, an orthographic projection of the common electrode line on the first base substrate extends through the first bonding region to the second bonding region, and the orthographic projection of the common electrode line on the first base substrate does not overlap with the orthographic projections of the first bonding terminals on the first base substrate.

In some embodiments, the plurality of input terminals include a plurality of first dummy terminals and a plurality of first input terminals; wherein the common electrode line includes a first common electrode line and a second common electrode line;
in the first peripheral region, an orthographic projection of the first common electrode line on the first base substrate is located on a side of the plurality of data lines in a direction in which the plurality of second bonding terminals point to the plurality of test terminals, and an orthographic projection of the second common electrode line on the first base substrate is located on the other side of the plurality of data lines in a direction in which the plurality of test terminals point to the plurality of second bonding terminals;
the first common electrode line includes a sixth portion, an orthographic projection of the sixth portion on the first base substrate overlaps with an orthographic projection of a region between adjacent first dummy terminals on the first base substrate, and the orthographic projection of the sixth portion on the first base substrate is located between orthographic projections of first portions of the plurality of test signal lines on the first base substrate and the orthographic projections of the plurality of first input terminals on the base first substrate;
the second common electrode line includes a seventh portion, and in the second direction, an orthographic projection of the seventh portion on the first base substrate is located on a side of the orthographic projections of the plurality of first input terminals on the first base substrate facing away from orthographic projections of the plurality of first dummy terminals on the first base substrate.

In some embodiments, the sixth portion includes a plurality of first sub-common electrode lines arranged along the second direction.

In some embodiments, the first common electrode line further includes an eighth portion electrically connected to the sixth portion at a side of the sixth portion close to the display region; an orthographic projection of the eighth portion on the first base substrate overlaps with orthographic projections of fourth portions of at least part of the test signal lines on the first base substrate, and the eighth portion and the fourth portions of the at least part of the test signal line are located in different layers;
the second common electrode line further includes a ninth portion electrically connected to the seventh portion at a side of the seventh portion close to the display region;
an orthographic projection of the ninth portion on the first base substrate overlaps with the orthographic projections of the fourth portions of the at least part of the test signal lines on the first base substrate, and the ninth portion and the fourth portions of the at least part of the test signal lines are located in different layers.

In some embodiments, the plurality of second output terminals include a third group and a fourth group;
the plurality of first connection leads are divided into a fifth group and a sixth group which extend to different second peripheral regions; first connection leads in the fifth group are electrically connected to second output terminals in the third group, and first connection leads in the sixth group are electrically connected to second output terminals in the fourth group;
in the first peripheral region, the orthographic projection of the first common electrode line on the first base substrate is located between an orthographic projection of the fifth group on the first base substrate and orthographic projections of the data lines on the first base substrate, and the orthographic projection of the second common electrode line on the first base substrate is located between an orthographic projection of the sixth group on the first base substrate and the orthographic projection of the data lines on the first base substrate.

In some embodiments, the display substrate further includes a first electrostatic unit electrically connected to the test terminals.

Some embodiments of the present disclosure provide a display panel, including the display substrate according to above embodiments.

In some embodiments, the display panel further includes:
an opposite substrate arranged opposite to the display substrate;
a liquid crystal layer located between the opposite substrate and the display substrate.

Some embodiments of the present disclosure provide a display device, including the display panel according to above embodiments.

### BRIEF DESCRIPTION OF FIGURES

In order to more clearly illustrate the technical solutions in the embodiments of the present disclosure, the drawings required for use in the description of the embodiments will be briefly introduced below. Obviously, the drawings described below are only some embodiments of the present disclosure. For ordinary technicians in this field, other drawings can be obtained based on these drawings without paying creative work.

FIG. 1 is a schematic diagram of a structure of a display product provided by the related art;

FIG. 2 is a schematic structural diagram of a display substrate provided in an embodiment of the present disclosure;

FIG. 3 is a schematic structural diagram of another display substrate provided in an embodiment of the present disclosure;

FIG. 4 is a schematic diagram of an enlarged region A in FIG. 3 provided in an embodiment of the present disclosure;

FIG. 5 is a schematic diagram of an enlarged region B in FIG. 4 provided in an embodiment of the present disclosure;

FIG. 6 is a schematic structural diagram of another display substrate provided in an embodiment of the present disclosure;

FIG. 7 is a schematic diagram of an enlarged C region in FIG. 3 provided in an embodiment of the present disclosure;

FIG. 8 is a schematic structural diagram of another display substrate provided in an embodiment of the present disclosure;

FIG. 9 is a schematic structural diagram of another display substrate provided in an embodiment of the present disclosure;

FIG. 10 is a schematic diagram of an enlarged D area in FIG. 9 provided in an embodiment of the present disclosure;

FIG. 11 is a schematic diagram of an enlarged E region in FIG. 9 provided in an embodiment of the present disclosure;

FIG. 12 is a schematic diagram of an enlarged G region in FIG. 10 provided in an embodiment of the present disclosure;

FIG. 13 is a schematic diagram of an enlarged F region in FIG. 9 provided in an embodiment of the present disclosure;

FIG. 14 is a schematic diagram of a structure of a first electrostatic unit provided in an embodiment of the present disclosure;

FIG. 15 is a schematic diagram of a structure of a display panel provided by an embodiment of the present disclosure;

FIG. 16 is a schematic diagram of a structure of a display device provided in an embodiment of the present disclosure.

### DETAILED DESCRIPTION

In order to make the purpose, technical solution and advantages of the embodiments of the present disclosure clearer, the technical solution of the embodiments of the present disclosure will be clearly and completely described below in conjunction with the drawings of the embodiments of the present disclosure. Obviously, the described embodiments are part of the embodiments of the present disclosure, not all of the embodiments. And in the absence of conflict, the embodiments in the present disclosure and the features in the embodiments can be combined with each other. Based on the described embodiments of the present disclosure, all other embodiments obtained by ordinary technicians in the field without creative work are within the scope of protection of the present disclosure.

Unless otherwise defined, the technical terms or scientific terms used in the present disclosure should be understood by people with ordinary skills in the field to which the present disclosure belongs. “First”, “second” and similar words used in the present disclosure do not indicate any order, quantity or importance, but are only used to distinguish different components. “Include” or “comprise” and similar words mean that the elements or objects appearing before the word cover the elements or objects listed after the word and their equivalents, without excluding other elements or objects. “Connect” or “connected” and similar words are not limited to physical or mechanical connections, but may include electrical connections, whether direct or indirect.

It should be noted that the sizes and shapes of the figures in the accompanying drawings do not reflect the actual proportions, and are only intended to illustrate the present disclosure. The same or similar reference numerals throughout represent the same or similar elements or elements having the same or similar functions.

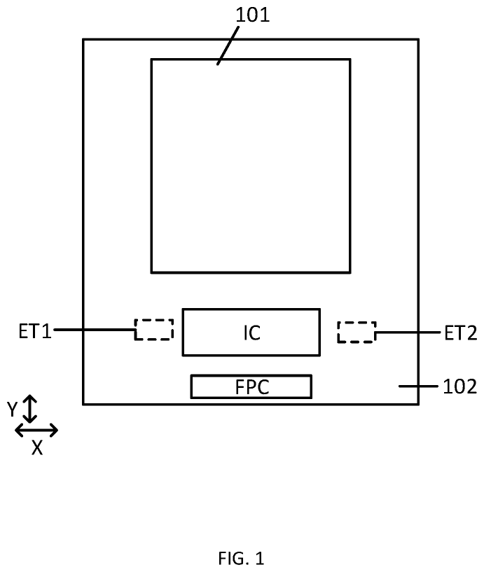

In the related art, after part of the manufacturing process of the display product is completed, before the driving chip and the flexible circuit board are bound, it is necessary to load an electrical signal to the display product for lighting test to determine whether there is a display abnormality in the display region. Usually, as shown in FIG. 1, the flexible circuit board FPC, the driving chip IC and the test terminals are all located in the peripheral region 102 below the display region 101, the flexible circuit board FPC is located directly below the driving chip IC, and the test terminals for testing are located in the regions ET1 and ET2 on both sides of the driving chip IC. For display products with low resolution, for example, the width of the driving chip IC in the second direction X is 15.36 millimeters (mm), which accounts for about ½ of the width of the display panel in the second direction X, and there is enough space on both sides of the driving chip to dispose the test terminals. Alternatively, the width of the driving chip in the second direction X is 10.02 mm, which accounts for about ⅔ of the width of the display panel in the second direction X, and the test terminals can be designed in double rows on both sides of the driving chip, that is, there is still space to set the test terminals on both sides of the driving chip. However, for narrow-bezel display products with higher resolution, in one solution, the width of the IC in the second direction X is 22.742 mm, and the width of the display panel in the second direction X is 25.1 mm, that is, the width of the driving chip in the second direction X is not much different from the width of the display panel in the second direction X. The remaining space on both sides of the driving chip cannot be used to dispose test terminals. If test terminals are still set on both sides of the driving chip, it will inevitably be necessary to increase the width of the peripheral region in the second direction X, affecting the user experience.

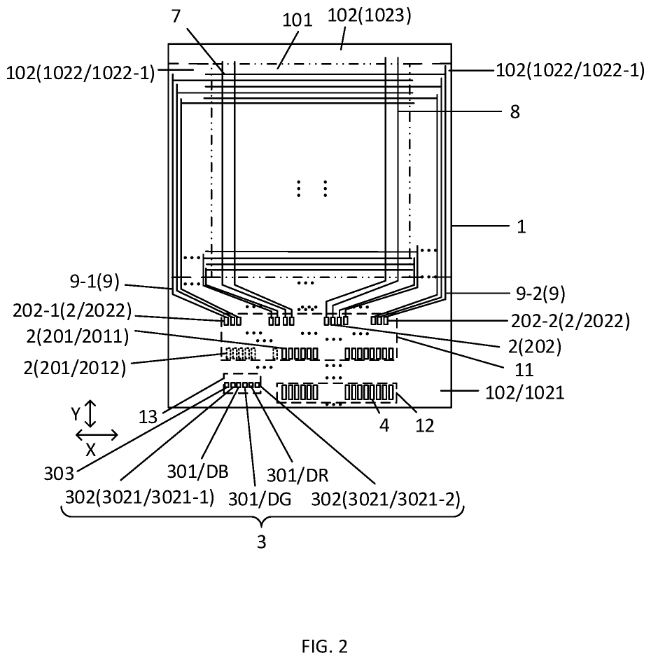

The present disclosure provides a display substrate, as shown in FIG. 2, the display substrate includes:
a first substrate 1 including: a display region 101 and a peripheral region 102 surrounding the display region 101; the peripheral region 102 includes a first peripheral region 1021 located at one side of the display region 101 in the first direction Y;
a plurality of first bonding terminals 2 located in the first peripheral region 1021; the plurality of first bonding terminals 2 are configured to be bonded with the driving chip;
a plurality of test terminals 3 located on the side of the first base substrate 1 same as the side where the first bonding terminals 2 are located in the first peripheral region 1021; the orthographic projections of the test terminals 3 on the first base substrate 1 are located on the side of the orthographic projections of the first bonding terminals 2 facing away from the display region 101 on the first base substrate 1.

In the display substrate provided by the embodiment of the present disclosure, the test terminal is arranged on a side of the first bonding terminals bonded to the driving chip facing away from the display region, so as to avoid the test terminals being located on both sides of the first bonding terminals in a second direction intersecting the first direction, resulting in an increase in the width of the peripheral region in the second direction, thereby avoiding affecting the user experience.

In some embodiments, as shown in FIG. 2, the display substrate further includes:
a plurality of second bonding terminals 4 located on the side of the first base substrate 1 same as the side where the plurality of first bonding terminals 2 are located in the first peripheral region 1021; the plurality of second bonding terminals 4 are configured to be bonded to the flexible circuit board, and at least some of the second bonding terminals 4 are electrically connected to at least some of the first bonding terminals 2; the orthographic projections of the plurality of second bonding terminals 4 on the first base substrate 1 are located on a side of the orthographic projections of the plurality of first bonding terminals 2 facing away from the display region 101 on the first base substrate 1; in the second direction X, the orthographic projections of the plurality of test terminals 3 on the first base substrate 1 are located on a side of the orthographic projections of the plurality of second bonding terminals 4 on the first base substrate 1, and the second direction X intersects with the first direction Y.

In the display substrate provided by the embodiment of the present disclosure, the test terminals and the second bonding terminals bonded to the flexible circuit board are all located on a side of the first bonding terminals facing away from the display region, and the test terminals are located on a side of the second bonding terminals in the second direction, so that the arrangement position of the test terminals will not affect the electrical connection between the second bonding terminals and the first bonding terminals.

It should be noted that in FIG. 2, the first direction Y is perpendicular to the second direction X, the second direction X is the horizontal direction in the figure, and the first direction Y is the vertical direction in the figure. In FIG. 2, the orthographic projections of the plurality of test terminals 3 on the first base substrate 1 is located on the left side of the orthographic projections of the plurality of second bonding terminals 4 on the first base substrate 1. In a specific implementation, the orthographic projections of the plurality of test terminals on the first base substrate may also be located on the right side of the orthographic projections of the plurality of second bonding terminals on the first base substrate.

In some embodiments, as shown in FIG. 2, the first peripheral region 1021 includes: a first bonding region 11 and a second bonding region 12 located on a side of the first bonding region 11 facing away from the display region 101. The orthographic projections of the first bonding terminals 2 on the first substrate 1 falls into the first bonding region 11, and the orthographic projections of the second bonding terminals 4 on the first substrate 1 falls into the second bonding region 12. The first peripheral region 1021 also includes a test terminal region 13. The first bonding region 11 is a region covered by the orthographic projection of the driving chip on the first substrate 1, and the second bonding region 12 is a region covered by the orthographic projection of the flexible circuit board on the first substrate 1. The test terminals 3 are located in the test terminal region 13. The driving chip is bonded to the first bonding terminals 2 in the first bonding region 11, and the flexible circuit board is bonded to the second bonding terminals 4 in the second bonding region 12.

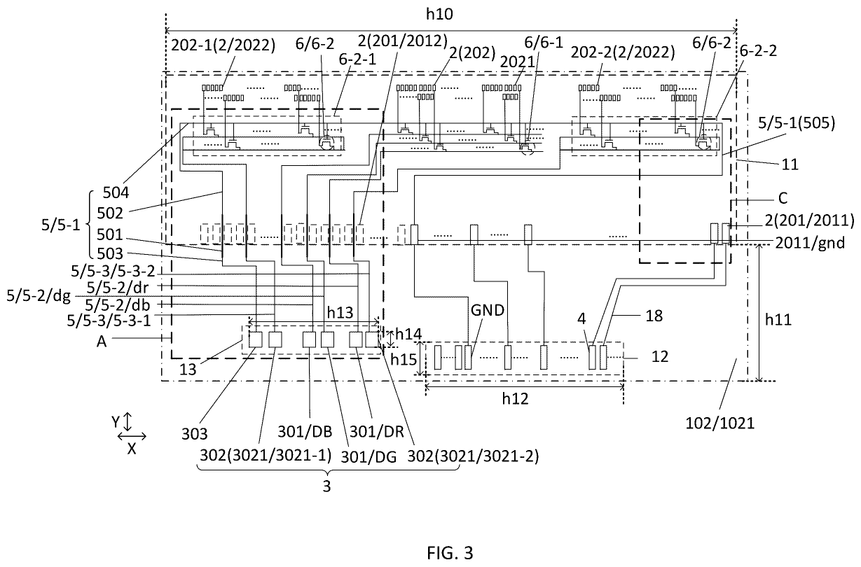

In some embodiments, as shown in FIG. 3, the width h10 of the first bonding region 11 in the second direction X is greater than the width h12 of the second bonding region 12 in the second direction X, the width h10 of the first bonding region 11 in the second direction X is greater than the width h13 of the test terminals 3 in the test terminal region 13 in the second direction X, and the width h10 of the first bonding region 11 in the second direction X is greater than the sum of the width h12 of the second bonding region 12 in the second direction X and the width h13 of the test terminals 3 in the test terminal region 13 in the second direction X.

In a specific implementation, h10 is approximately 22 mm, the width of the first peripheral region in the second direction X is approximately 25 mm, h12 is approximately 15 mm, and h13 is approximately 3.5 mm.

In some embodiments, as shown in FIG. 3, in the first direction Y, the distance from the first bonding region 11 to the edge of the first peripheral region 102 facing away from the display region is h11, the width of the test terminal 3 is h14, the width of the second bonding region 12 is h15, h11 is greater than h14, and h11 is greater than h15.

In a specific implementation, h11 is approximately 1 mm, h14 is approximately 0.3 mm, and h15 is approximately 0.4 mm.

In specific implementation, the first bonding region, i.e., the region covered by the orthographic projection of the driving chip on the first substrate, is usually rectangular, and the second bonding region, i.e., the region covered by the orthographic projection of the flexible circuit board on the first substrate, is usually also rectangular. In the display substrate provided by the embodiment of the present disclosure, the center of the first bonding region and the center of the second bonding region are located on different straight lines in the first direction. That is, the region bound by the flexible circuit board is not directly opposite to the region bound by the driving chip. Compared with the situation where the center of the flexible circuit board is directly opposite to the center of the driving chip, i.e., the center line connecting the two is parallel to the first direction, the display substrate provided by the embodiment of the present application is equivalent to moving the region bound by the flexible circuit board toward the edge in the second direction, thereby providing sufficient wiring space for the test terminals.

In some embodiments, as shown in FIG. 2, the plurality of first bonding terminals 2 include:
a plurality of input terminals 201; at least some of the input terminals 201 are arranged along the second direction X;
a plurality of output terminals 202 located on a side of the plurality of input terminals 201 facing the display region 101.

The plurality of test terminals 3 are located on a side of the plurality of input terminals 201 facing away from the display region 101.

In a specific implementation, the test terminals are electrically connected to the output terminals.

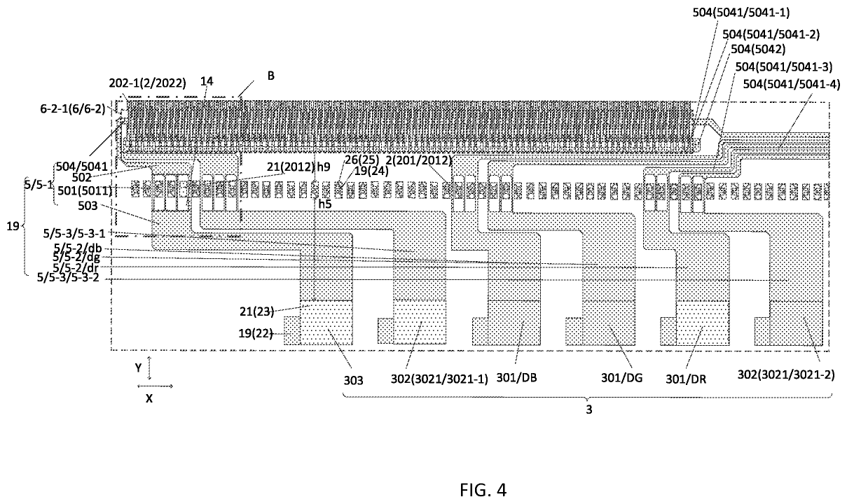

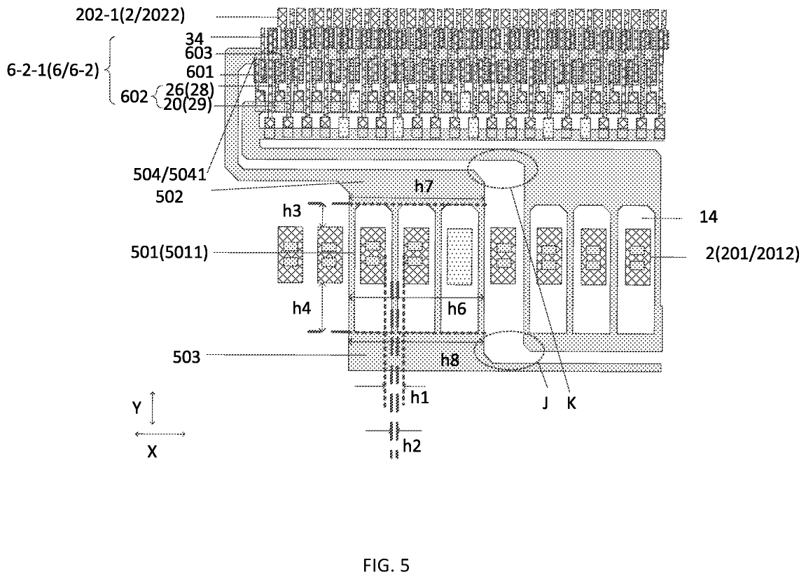

In some embodiments, as shown in FIG. 3, FIG. 4, and FIG. 5, the display substrate further includes:
a plurality of test signal lines 5 located in a first peripheral region; each of the plurality of test signal lines 5 is electrically connected to a test terminal 3; the test signal lines 5 include: a first portion 501, the orthographic projection of the first portion 501 on the first substrate 1 and the orthographic projections of the input terminal 201 on the first substrate 1 do not overlap each other, and the orthographic projection of the first portion 501 on the first substrate 1 overlaps with the orthographic projection of a region between the adjacent input terminals 201 on the first substrate 1. The test signal lines 5 are electrically connected to the output terminals 202.

In the display substrate provided by the embodiment of the present disclosure, the test signal lines are electrically connected to the output terminals and the test terminals, that is, the test signal lines need to extend from the first bonding region to the test terminal region. The orthographic projection of the first portion of the test signal lines on the first base substrate and the orthographic projections of the input terminals on the first base substrate do not overlap each other, and the orthographic projection of the first portion on the first base substrate overlaps with the orthographic projection of the region between the adjacent input terminals on the first base substrate, that is, the test signal lines pass through the space between each two adjacent input terminals and are electrically connected to the test terminals, thereby avoiding interference of the test signal lines on the input terminals.

In a specific implementation, the number of test signal lines is equal to the number of test terminals.

In some embodiments, the display substrate further includes:
a plurality of sub-pixel units located on the side of the first base substrate same as the side where the plurality of first bonding terminals are located in the display region.

In a specific implementation, at least part of the output terminals are electrically connected to the sub-pixel units arranged in the display region, so that the test terminals are electrically connected to the sub-pixel units through the test signal lines and the output terminals to implement lighting test on the sub-pixel units through the test terminals.

It should be noted that FIG. 3 is a simple schematic diagram of a portion of the first peripheral region, and FIG. 4 is a schematic diagram of a structure of an enlarged region A in FIG. 3. FIG. 5 is a schematic diagram of a structure of an enlarged region B in FIG. 4.

In some embodiments, as shown in FIG. 2 and FIG. 3, the plurality of input terminals 201 include: a plurality of first input terminals 2011, and a plurality of first dummy terminals 2012 located on a side of the plurality of first input terminals 2011 in a direction in which the plurality of second bonding terminals 4 point to the plurality of test terminals 3.

The plurality of first input terminals 2011 are electrically connected to at least some of the second bonding terminals 4.

It should be noted that the first dummy terminals do not need to be electrically connected to any conductive structure of the display substrate, but the first dummy terminals still need to be bonded to the driving chip. The first dummy terminals can support the driving chip and balance the thickness of the structure of the first bonding region. It is also possible to provide a signal to the driving chip from the outside of the display substrate through the first dummy terminals, or to lead out the signal of the driving chip through the first dummy terminals.

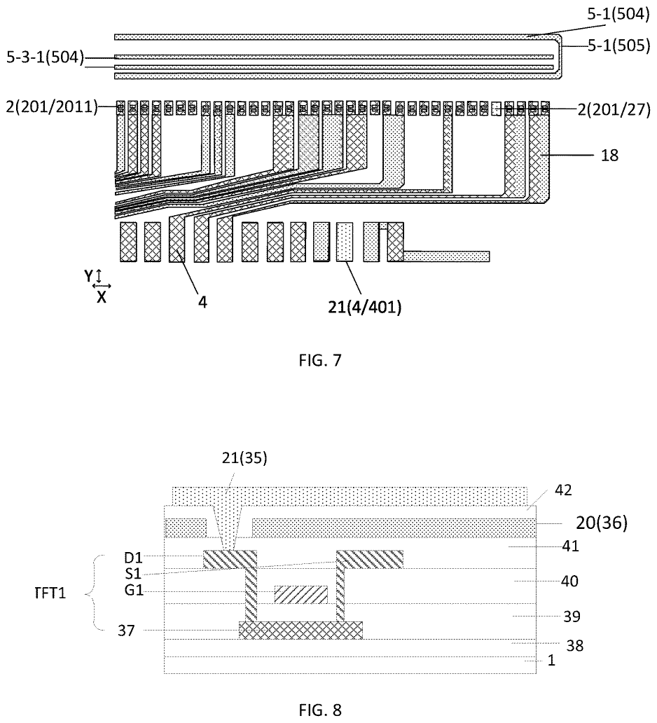

It should be noted that, as shown in FIG. 7, in the region where the plurality of first input terminals 2011 are arranged, the plurality of input terminals 2 may further include a plurality of second dummy terminals 27, and at least part of the plurality of second dummy terminals 27 may be located between two adjacent first input terminals 2011. In a specific implementation, the second dummy terminals do not need to be electrically connected to any conductive structure of the display substrate, but the second dummy terminals still need to be bonded to the driving chip. The second dummy terminals may support the driving chip and balance the thickness of the structure of the first bonding region. It is also possible to provide a signal to the driving chip from the outside of the display substrate through the second dummy terminals, or to lead out the signal of the driving chip through the second dummy terminals.

It should be noted that FIG. 7 is a schematic diagram of an enlarged C region in FIG. 3.

In some embodiments, as shown in FIG. 4 and FIG. 5, the orthographic projection of the first portion 501 on the first substrate and the region between the adjacent first input terminals 2011 do not overlap with each other, and the orthographic projection of the first portion 501 on the first substrate overlaps the region between the adjacent first dummy terminals 2012.

In the display substrate provided by the embodiment of the present disclosure, the first portion of the test signal lines passes through the region between adjacent first dummy terminals and is electrically connected to the test terminal located on the side of the plurality of first dummy terminals away from the display region. Since the first dummy terminals do not need to be electrically connected to any conductive structure of the display substrate, the first portion passes through the region between adjacent first dummy terminals and will not interfere with other conductive structures. In addition, the first portion passes through the region between adjacent first dummy terminals instead of the region between adjacent first input terminals, thereby avoiding interference of the test signal lines to the first input terminals while reasonably utilizing the display substrate space.

In some embodiments, as shown in FIG. 4 and FIG. 5, the first portion 501 includes a plurality of first sub-signal lines 5011 arranged along the second direction X. That is, the orthographic projection of each first sub-signal line on the first base substrate 1 overlaps with the orthographic projection of the region between the adjacent first dummy terminals 2012 on the first base substrate 1.

It should be noted that the test signal lines extend from the first bonding region through the regions between the first dummy terminals to the test terminal region and are connected to the test terminals. As shown in FIG. 5, in the second direction X, the distance h1 between two adjacent first dummy terminals 2012 is about 20 microns, and the width h2 of the first sub-signal line 5011 in the region between the two adjacent first dummy terminals 2012 is less than the distance h1 between the two adjacent first dummy terminals 2012, so the width h2 of the first sub-signal line 5011 is smaller. Therefore, disposing only one first sub-signal line will result in a large impedance of the first portion, affecting the test signal transmission.

In the display substrate provided by the embodiment of the present disclosure, the first portion of each test signal line includes a plurality of first sub-signal lines, thereby improving the electrical connection performance between the first portion and the remaining portions, reducing the impedance of the test signal line, and avoiding affecting the test signal transmission.

In some embodiments, in the second direction X, the width h2 of the first sub-signal line in the region between two adjacent first dummy terminals is about 10 micrometers, thereby preventing the first sub-signal line from being too close to the first dummy terminal, causing the driving chip to short-circuit with the first sub-signal lines when bonding with the first dummy terminals.

In specific implementation, the number of first sub-signal lines included in the first portion can be selected according to actual needs. For example, it can be specifically set according to the width of the part connected to the first portion in the second direction X.

In some embodiments, as shown in FIG. 4 and FIG. 5, the test signal lines 5 also include: a second portion 502 and a third portion 503 respectively connected to the two ends of the first portion 501 in the extension direction of the first portion 501. The second portion 502 is located on a side of the first portion 501 facing the display region 101, and the third portion 503 is located on a side of the first portion 501 facing away from the display region 101.

In a specific implementation, as shown in FIG. 5, the second portion 502 and the third portion 503 are both single wirings. The second portion 502, the third portion 503 and the plurality of first sub-signal lines 5011 surround a plurality of opening regions 14, and the orthographic projections of the first dummy terminals 2012 on the first base substrate 1 fall within the orthographic projection of the opening region 14 on the first base substrate 1.

In some embodiments, as shown in FIG. 5, in the second direction X, the width of the first sub-signal line 5011 is smaller than the width of the second portion 502 at the connection with the first portion 501 and the width of the first sub-signal line 5011 is smaller than the width of the third portion 503 at the connection with the first portion 501.

In some embodiments, as shown in FIG. 5, an edge 15 of at least one first sub-signal line 5011 extending along the first direction Y and an edge 16 of the second portion 502 extending along the first direction Y are located in the same straight line, and an edge 15 of at least one first sub-signal line 5011 extending along the first direction Y and an edge 17 of the third portion 503 extending along the first direction Y are located in the same straight line. Thus, as many first sub-signal lines connected to the second portion and the third portion are provided as possible, which is beneficial to reducing the impedance of the test signal lines.

In some embodiments, as shown in FIG. 5, in the second direction X, the width h6 of the region where the first portion 501 is located is not greater than the width h7 of the second portion 502, and the width h6 of the region where the first portion 501 is located is not greater than the width h8 of the third portion 503. For each test signal line 5, in the second direction X, the width h6 of the region where the first portion 501 is located is equal to the width h7 of the second portion 502, and/or the width h6 of the region where the first portion 501 is located is equal to the width h8 of the third portion 503. That is, for each test signal line 5, h6=h7, h6<h8, or h6=h8, h6<h7, or h6=h7, h6=h8.

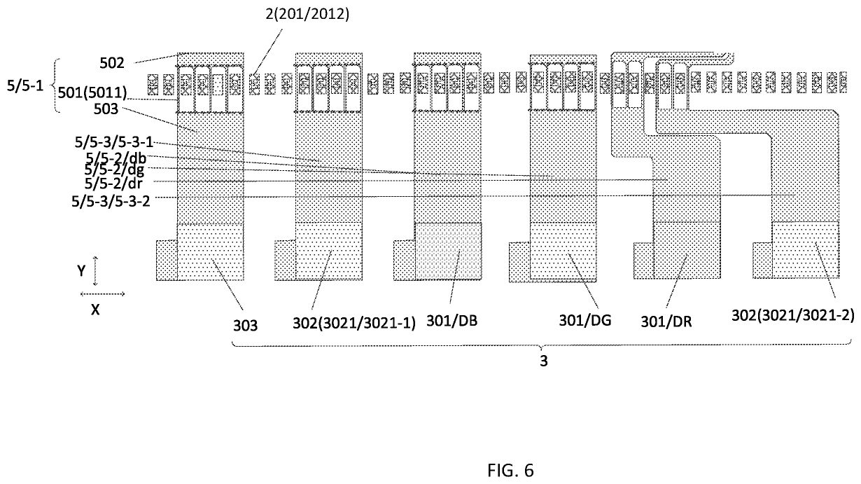

It should be noted that, in FIG. 4, the third portion 503 of each test signal line 3 includes a portion extending along the first direction Y and a portion extending along the second direction X. The second portion 502 of some test signal lines 3 includes a portion extending along the first direction Y and a portion extending along the second direction X, and the second portion 502 of some test signal lines 3 only includes a portion extending along the second direction X. In a specific implementation, the pattern of the second portion and the pattern of the third portion can be designed according to the wiring space available. For example, as shown in FIG. 6, at least the third portion 503 of some test signal lines 3 can only include a portion extending along the first direction Y. That is, when the wiring space allows, the test signal lines can extend directly from the test signal terminals upward (i.e., toward the side of the display region) to the first bonding region.

In some embodiments, as shown in FIG. 2, FIG. 3, and FIG. 4, a plurality of test terminals 3 are sequentially arranged along the second direction X.

As shown in FIGS. 3 and 4, the first portions 501 of the plurality of test signal lines 5 are sequentially arranged along the second direction X, the second portions 502 of the plurality of test signal lines 5 are sequentially arranged along the second direction X, and the third portions 503 of the plurality of test signal lines 5 are sequentially arranged along the second direction X.

In some embodiments, as shown in FIG. 3, the display substrate further includes:
a plurality of transistors 6 located on the side of the first substrate 1 same as the side where the plurality of first bonding terminals 2 are located in the first peripheral region 1021; the orthographic projections of the plurality of transistors 6 on the first substrate 1 are located between the orthographic projections of the plurality of output terminals 202 on the first substrate 1 and the orthographic projections of the plurality of input terminals 201 on the first substrate 1; the plurality of transistors 6 include: a plurality of first transistors 6-1, and a plurality of second transistors 6-2 located at least on a side of the plurality of first transistors 6-1 in the second direction X.

The output terminals 202 include: a plurality of first output terminals 2021, and a plurality of second output terminals 2022 located at least on a side of the first output terminals 2021 in the second direction X; the test signal lines 5 include: a control signal line 5-1, a plurality of first signal lines 5-2, and at least one second signal line 5-3.

The plurality of test terminals 3 include: a control terminal 303, a plurality of first test terminals 301, and a second test terminal 302.

In some embodiments, as shown in FIG. 3, the orthographic projections of the plurality of transistors 6 on the first substrate fall into the first bonding region 11.

In some embodiments, as shown in FIG. 5, each of the plurality of transistors 6 includes: a control electrode 601, a first electrode 602, a second electrode 603, and an active layer 34.

The first electrode 602 of the first transistor 6-1 is electrically connected to the first output terminal 2021, and the first electrode 602 of the second transistor 6-2 is electrically connected to the second output terminal 2022.

The control terminal 303 is electrically connected to the control electrodes 601 of the transistors 6 through the control signal line 5-1. The first test terminal 301 is electrically connected to the second electrodes 603 of some first transistors 6-1 through the first signal line 5-2. The second test terminal 302 is electrically connected to the second electrodes 603 of at least some second transistors 6-2 through the second signal line 5-3.

In a specific implementation, a control signal is applied to a control terminal to control the transistor to turn on, a first test signal is transmitted to the sub-pixel unit through a first signal line, a first transistor, and an output terminal electrically connected to the first transistor, and a second test signal is transmitted to the sub-pixel unit through a second signal line, a second transistor, and an output terminal electrically connected to the second transistor, so as to light up the sub-pixel unit and determine whether there is a display abnormality.

In a specific implementation, the transistor is, for example, a thin film transistor, the control electrode of the transistor is the gate of the thin film transistor, one of the first electrode and the second electrode of the transistor is the source of the thin film transistor, and the other of the first electrode and the second electrode of the transistor is the drain of the thin film transistor.

In a specific implementation, in order to avoid increasing the width of the driving chip in the second direction X and thus avoiding increasing the width of the display substrate in the second direction X, the output terminals can be arranged in multiple rows along the first direction Y, and the transistors can also be arranged in multiple rows along the first direction Y. For example, as shown in FIG. 3, the output terminals 202 are arranged in two rows along the first direction Y, the first transistors 6-1 are arranged in three rows along the first direction Y, and the second transistors 6-2 located on a side of the first transistors 6-1 are arranged in two rows along the first direction Y.

In a specific implementation, as shown in FIG. 4, the third portion 503 is a portion located outside the first bonding region, the second portion 502 is a portion located within the first bonding region, and the second portion 502 is located between the transistor 6 and the first dummy terminal 2012. As shown in FIG. 5, in the first direction Y, the distance between the second portion 502 and the first dummy terminal 2012 is h3, and the distance between the third portion 503 and the first dummy terminal 2012 is h4, h3=h4. Alternatively, h3 is not equal to h4. In the first direction Y, the distance h5 between the first dummy terminal 2012 and the test terminal 3 is about 400 microns, and the distance h9 between the first dummy terminal 2012 and the transistor 6 is about 150 microns, that is, the wiring space between the first dummy terminal 2012 and the transistor 6 is smaller, and the wiring space between the first dummy terminal 2012 and the test terminal 3 is larger. Therefore, it can be set to h3<h4. In some embodiments, in the first direction Y, a distance h3 between the second portion 502 and the first dummy terminal 2012 is approximately 40 micrometers, and a distance h4 between the third portion 503 and the first dummy terminal 2012 is approximately 80 micrometers.

In some embodiments, as shown in FIG. 2, the peripheral region 102 further includes second peripheral regions 1022 located on both sides of the display region 101 in the second direction X; the display substrate further includes:
a plurality of scanning lines 7 electrically connected to a plurality of sub-pixel units (not shown), and extending from the display region 101 to the second peripheral regions 1022; the plurality of scanning lines 7 are arranged along the first direction Y and extend along the second direction X;
a plurality of data lines 8 electrically connected to the plurality of sub-pixel units and extending from the display region 101 to the peripheral regions 102; the plurality of data lines 8 are arranged along the second direction X and extend along the first direction Y; each of the plurality of data lines 8 is electrically connected to the first output terminal 2021;
a plurality of first connection leads 9 extend from the first peripheral region 1021 to the second peripheral regions 1022; two ends of each of the plurality of first connection leads 9 are electrically connected to a second output terminal 2022 and a scanning line 7, respectively.

In a specific implementation, the sub-pixel unit includes a first thin film transistor, a gate of the first thin film transistor is electrically connected to a scanning line, and a source of the first thin film transistor is electrically connected to a data line.

In a specific implementation, the sub-pixel units include multiple sub-pixel units with different light-emitting colors. Both the number of first test terminals and the number of first signal lines are equal to the numbers of types of the sub-pixel units. For example, the sub-pixel units include: red sub-pixel units, blue sub-pixel units, and green sub-pixel units. Correspondingly, as shown in FIG. 3, the display substrate includes: three first test terminals 301 and three first signal lines 5-2. The three first test terminals 301 are DB, DG, and DR, respectively, and the three first signal lines 5-2 are db, dg, and dr, respectively. The blue screen is detected through DB and db, the green screen is detected through DG and dg, and the red screen is detected through DR and dr.

In some embodiments, as shown in FIG. 3, in the second direction X, the control terminal 303 is located on a side of the remaining test terminals 3 facing away from the plurality of second bonding terminals 4.

In some embodiments, as shown in FIG. 3, the second test terminal 302 includes at least one sub-test terminal 3021. In the second direction X, at least one sub-test terminal 3021 is located between the first test terminals 301 and the control terminal 303, or at least one sub-test terminal 3021 is located on a side of the multiple first test terminals 301 facing away from the control terminal 303.

In some embodiments, as shown in FIG. 2, the plurality of first connection leads 9 are divided into a fifth group 9-1 and a sixth group 9-2 extending to different second peripheral regions 1022.

The plurality of second output terminals 2022 are divided into: a third group 202-1 located at a side of the plurality of first output terminals 2021 in the direction in which the plurality of first test terminals 301 point to the first category of second test terminal 3021-1, and a fourth group 202-2 located at a side of the plurality of second output terminals 2022 in the direction in which the plurality of first test terminals 301 point to the second category of second test terminal 3021-2.

The first connection lead 9 in the fifth group 9-1 is electrically connected to the second output terminal 2022 in the third group 202-1, and the first connection lead 9 in the sixth group 9-2 is electrically connected to the second output terminal 2022 in the fourth group 202-2.

It should be noted that FIG. 2 uses the example in which the fifth group 9-1 extends to the second peripheral region 1022-1 on the left side of the display region 101, the sixth group 9-2 extends to the second peripheral region 1022-2 on the right side of the display region 101, the third group 202-1 is located on the left side of the first output terminals 2021, and the fourth group 202-2 is located on the right side of the multiple first output terminals 2021 for illustration.

In a specific implementation, the first connection lead in the fifth group and the first connection lead in the sixth group are connected to different rows of scanning lines. The first connection lead in the fifth group is electrically connected to the odd-numbered scanning lines, and the first connection lead in the sixth group is electrically connected to the even-numbered scanning lines. Alternatively, the first connection lead in the fifth group is electrically connected to the even-numbered scanning lines, and the first connection lead in the sixth group is electrically connected to the odd-numbered scanning lines. That is, the first connection leads electrically connected to the scanning lines are respectively located in the two second peripheral regions on both sides of the display region, so that the width of the second peripheral region can be prevented from increasing when the first connection leads are located in one of the second peripheral regions, which is conducive to realizing narrow bezel display.

Accordingly, in some embodiments, as shown in FIG. 3, the plurality of test terminals 3 include two second test terminals 302, and the two second test terminals 302 are respectively a first category of second test terminal 3021-1 located between the plurality of first test terminals 301 and the control terminal 303, and a second category of second test terminal 3021-2 located on a side of the plurality of first test terminals 301 facing away from the control terminal 303.

The plurality of signal lines 5 include two second signal lines 5-3, the two second signal lines 5-3 are respectively a first category of second signal line 5-3-1 located between the plurality of first signal lines 5-2 and the control signal line 5-1, and a second category of second signal line 5-3-2 located on a side of the plurality of first signal lines 5-2 facing away from the control signal line 5-1.

The plurality of second transistors 6-2 are divided into: a first group 6-2-1 located at a side of the plurality of first transistors 6-1 in a direction in which the plurality of first test terminals 301 point to the first category of second test terminal 3021-1, and a second group 6-2-2 located at a side of the plurality of first transistors 6-1 in a direction in which the plurality of first test terminals 301 point to the second category of second test terminal 3021-2. The second output terminal 2022 in the third group 202-1 is electrically connected to the second transistor 6-2 of the first group 6-2-1, and the second output terminal 2022 in the fourth group 202-2 is electrically connected to the second transistor 6-2 of the second group 6-2-2.

The first category of second test terminal 3021-1 is electrically connected to the second electrode of the first group 6-2-1 through the first category of second signal line 5-3-1, and the second category of second test terminal 3021-2 is electrically connected to the second electrode of the second group 6-2-2 through the second category of second signal line 5-3-2.

That is, in a specific implementation, a second test signal is loaded onto the first category of second test terminal to transmit the second test signal to the scanning line electrically connected to the first connection lead in the fifth group through the first category of second signal line, the first transistor in the first group, the second output terminal in the third group, and the first connection lead in the fifth group. The second test signal is loaded onto the second category of second test terminal to transmit the second test signal to the scanning line electrically connected to the first connection lead in the sixth group through the second category of second signal line, the first transistor in the second group, the second output terminal in the fourth group, and the first connection lead in the sixth group.

It should be noted that, since the data lines are directly extended to the first peripheral region and electrically connected to the first output terminals, the first connection lead in the fifth group and the first connection lead in the sixth group are respectively located on both sides of the plurality of data lines, so that the fifth group, the third group, and the first group are located on the same side, and the sixth group, the fourth group, and the first group are located on the same side, which can avoid increasing the wiring difficulty of the display substrate while reasonably using the wiring space. Accordingly, the control signal terminal is located on a side farthest from the second bonding terminals, the second signal terminal of first category is located between the control signal terminal and the first signal terminal, and the second signal terminal of second category is located on the side of the first signal terminal facing away from the control signal terminal, which can also avoid increasing the wiring difficulty of the display substrate while reasonably using the wiring space.

In some embodiments, as shown in FIG. 3, the test signal line 5 further includes a fourth portion 504 electrically connected to the second portion 502.

At least a portion of the fourth portion 504 extends along the second direction X, and the orthographic projection of the fourth portion 504 on the first base substrate 1 is located between the orthographic projections of the plurality of output terminals 202 on the first base substrate 1 and the orthographic projections of the plurality of input terminals 201 on the first base substrate 1.

The fourth portions 504 of the control signal lines 5-1 are electrically connected to the control electrodes of the plurality of transistors 6. A fourth portion 504 of the first signal line 5-2 is electrically connected to the second electrode of the first transistor 6-1, and a fourth portion 504 of the second signal line 5-3 is electrically connected to the second electrode of the second transistor 6-2.

a fourth portion 504 of the first signal line 5-2 is located on a side of the fourth portion 504 of the control signal line 5-1 facing away from the display region 101, and a fourth portion 504 of the second signal line 5-3 is located on a side of the fourth portion 504 of the control signal line 5-1 facing away from the display region 101.

In a specific implementation, the control signal line is electrically connected to the control electrode of the first transistor and the control electrode of the second transistor. The fourth portion of the control signal line is closer to the display region than the fourth portions of the remaining test signal lines. The second portion, the first portion, and the third portion of the control signal line are farther away from the second bonding terminal than the second portion, the first portion, and the third portion of the remaining test signal lines. This makes the control signal line located outside the remaining test signal lines, which is conducive to rational use of the space in the first peripheral region and avoidance of interference between different test signal lines.

In some embodiments, as shown in FIG. 3, when the second test terminal 302 includes a first category of second test terminal 3021-1 and a second category of second test terminal 3021-2;
the fourth portion 504 of the first category of second signal line 5-3-1 electrically connected to the first category of second test terminal 3021-1 is located between the fourth portion 504 of the control signal line 5-1 and at least part of the fourth portion 504 of the first signal lines 5-2, and the fourth portion 504 of the second category of second signal line 5-3-2 electrically connected to the second category of second test terminal 3021-2 is located on a side of the fourth portions 504 of the first signal lines 5-2 facing away from the fourth portion 504 of the control signal line 5-1.

In a specific implementation, as shown in FIG. 4, the fourth portion 504 of each test signal line 5 can be divided into a plurality of first sub-portions 5041 extending along the second direction X. The orthographic projections of at least part of the first sub-portions 5041 on the first base substrate 1 extend to the region of the orthographic projections of the plurality of transistors 6 on the first base substrate 1. The extension lines of different first sub-portions 5041 can be located on different straight lines. The fourth portion 504 can also be divided into second sub-portion 5042 extending along a direction intersecting the second direction X, and the extension line of the second sub-portions 5042 can be located on the different straight lines where the firs sub-portions 5041 are located.

In a specific implementation, in FIG. 3, the second transistors 6-2 in the first group 6-2-1 are arranged in two rows, and correspondingly, the first category of second signal line 5-3-1 includes two first sub-portions 5041, and the two first sub-portions 5041 are electrically connected to the two rows of second transistors 6-2, respectively. As shown in FIG. 4, in the first direction Y, one of the first sub-portions 5041 (marked as 5041-1 in the figure) is located between the other first sub-portion 5041 (marked as 5041-2 in the figure) and the first sub-portion 5041 of the control signal line 5-1. One end of the extension direction of the two first sub-portions 5041 is connected to the portion of the second portion 502 extending along the first direction Y. The first category of second signal line 5-31 also includes a second sub-portion 5042 connected to the two first sub-portions 5041 at one end of the two first sub-portions 5041 facing away from the end of the two first sub-portions 5041 connected with the second portion 502.

In a specific implementation, in FIG. 4, each first signal line 5-2 includes two first sub-portions 5041, one (marked as 5041-3 in the figure) of which is located between the first group 6-2-1 and the first dummy terminal 2012, and the orthographic projection of the first sub-portion 5041 marked as 5041-3 in the figure on the first base substrate 1 does not overlap with the orthographic projections of the transistors 6 on the first base substrate 1. The other first sub-portion 5041 (marked as 5041-4 in the figure) extends to a region where a plurality of first transistors (not shown) are disposed.

In some embodiments, as shown in FIG. 3 and FIG. 7, the control signal line 5-1 further includes a fifth portion 505. The fifth portion 505 is electrically connected to the fourth portion 504 at an end of the fourth portion 504 facing away from the second portion 502.

The plurality of first input terminals 2011 include a first ground-level signal input terminal gnd. The fifth portion 505 is electrically connected to the first ground-level signal input terminal gnd.

It should be noted that transistors are not shown in FIG. 7.

In some embodiments, as shown in FIG. 3 and FIG. 7, the first input terminals 2011 are electrically connected to the second bonding terminals 4 through the second connection leads 18. The second bonding terminals 4 include a ground-level signal bonding terminal GND, and the first ground-level signal input terminal gnd is electrically connected to the ground-level signal bonding terminal GND through the second connection lead 18.

That is, in the display substrate provided by the embodiment of the present disclosure, one end of the control signal line is electrically connected to the control signal terminal, and the other end of the control signal line is electrically connected to the ground-level signal bonding terminal. Therefore, after bonding the driving chip and the flexible circuit board, the other end of the control signal line is grounded, so that after bonding the driving chip and the flexible circuit board, the potential of the control signal line can be pulled down to avoid the transistor electrically connected to the control signal line from being accidentally turned on.

In some embodiments, as shown in FIG. 7, the second bonding terminals 4 include a plurality of third dummy terminals 401.

It should be noted that the third dummy terminal does not need to be electrically connected to any conductive structure of the display substrate, but the third dummy terminal still needs to be bonded to the flexible circuit board. The third dummy terminal can support the flexible circuit board and balance the thickness of the structure of the second bonding region.

In some embodiments, the display substrate provided by the embodiments of the present disclosure may be applied to electroluminescent display, and the sub-pixel unit of the display substrate further includes an electroluminescent device electrically connected to the thin film transistor of the sub-pixel unit.

Alternatively, in some embodiments, the display substrate provided by the embodiments of the present disclosure may be applied to liquid crystal display. As shown in FIG. 8, the sub-pixel unit further includes a pixel electrode 35 electrically connected to the first thin film transistor TFT1. The display substrate further includes a common electrode 36.

In a specific implementation, as shown in FIG. 8, the first thin film transistor TFT1 includes a first active layer 37, a first gate electrode G1, a first source electrode S1 and a first drain electrode D1. The first thin film transistor TFT1 shown in FIG. 8 is a top gate structure, that is, the first gate electrode G1 is located on a side of the first active layer 37 facing away from the first base substrate 1. The display substrate further includes a buffer layer 38 located between the first active layer 37 and the first base substrate 1, a gate insulating layer 39 located between the first gate electrode G1 and the first active layer 37, and an interlayer insulating layer 40 located between the first active layer 37 and the first source electrode S1 and the first drain electrode D1.

In a specific implementation, the display substrate includes a first conductive layer, a second conductive layer located on a side of the first conductive layer facing away from the first base substrate, a third conductive layer located on a side of the second conductive layer facing away from the first conductive layer, and a fourth conductive layer located on a side of the third conductive layer facing away from the second conductive layer. The first conductive layer includes a control electrode of the first transistor, a control electrode of the second transistor, and a gate electrode of the first thin film transistor. The second conductive layer includes a source electrode and a drain electrode of the first thin film transistor. The third conductive layer and the fourth conductive layer are transparent conductive layers, and one of the third conductive layer and the fourth conductive layer includes pixel electrodes, and the other includes common electrodes. FIG. 8 takes the example that the third conductive layer 20 includes a common electrode 36 and the fourth conductive layer 21 includes a pixel electrode 35 as an example for illustration. In a specific implementation, as shown in FIG. 8, the display substrate also includes a first insulating layer 41 located between the common electrode 36 and the first source electrode S1 and the first drain electrode D1, and a second insulating layer 42 located between the pixel electrode 35 and the common electrode 36.

In a specific implementation, as shown in FIG. 4, the test signal lines 5 are located in the first conductive layer 19. The test terminal 3 includes a first sublayer 22 and a second sublayer 23 which are electrically connected to each other. The first sublayer 22 is located in the first conductive layer 19, the second sublayer 23 is located in the fourth conductive layer 21. The first sublayer 22 is integrally connected to the test signal lines 5. Of course, the second sublayer may also be located in the third conductive layer. A part of the input terminals 201 include a third sublayer 24 and a fourth sublayer 25 which are electrically connected to each other. The third sublayer 24 is located in the first conductive layer 19, the fourth sublayer 25 is located in the second conductive layer 26. A part of the first dummy terminals 2012 and the second dummy terminal 27 are located in the fourth conductive layer 21. Of course, the part of the first dummy terminal and the second dummy terminal may also be located in the third conductive layer. In a specific implementation, the bonding status of the driving chip can be checked through the first dummy terminals and/or the second dummy terminals located in the third conductive layer or the fourth conductive layer. As shown in FIG. 5, the first electrode 602 of the transistor 6 includes a fifth sublayer 28 and a sixth sublayer 29 which are electrically connected to each other. The fifth sublayer 28 is located in the second conductive layer 26, the sixth sublayer 29 is located in the fourth conductive layer 21, and the sixth sublayer 29 is electrically connected to the first signal line (not shown) or the second signal line 5-3. The second electrode 603 of the transistor 6 is located in the second conductive layer 26. Of course, the sixth sublayer can also be located in the third conductive layer.

In a specific implementation, as shown in FIG. 7, a part of the third dummy terminals 401 are located on the fourth conductive layer 21. Alternatively, a part of the third dummy terminals are located on the third conductive layer, so that the boding status of the flexible circuit board can be checked through the third dummy terminals located on the third conductive layer or the fourth conductive layer.

In a specific implementation, the remaining second bonding terminals except the third dummy terminals located in the third conductive layer or the fourth conductive layer include a seventh sublayer and an eighth sublayer which are electrically connected to each other. The second connection lead includes the ninth sublayer and the tenth sublayer. The seventh sublayer and the ninth sublayer are located in the first conductive layer, and the eighth sublayer and the tenth sublayer are located in the second conductive layer.

In a specific implementation, the second connection lead may also be double-layered, that is, the second connection lead includes an eleventh sub-layer located in the first conductive layer and a twelfth sub-layer located in the second conductive layer.

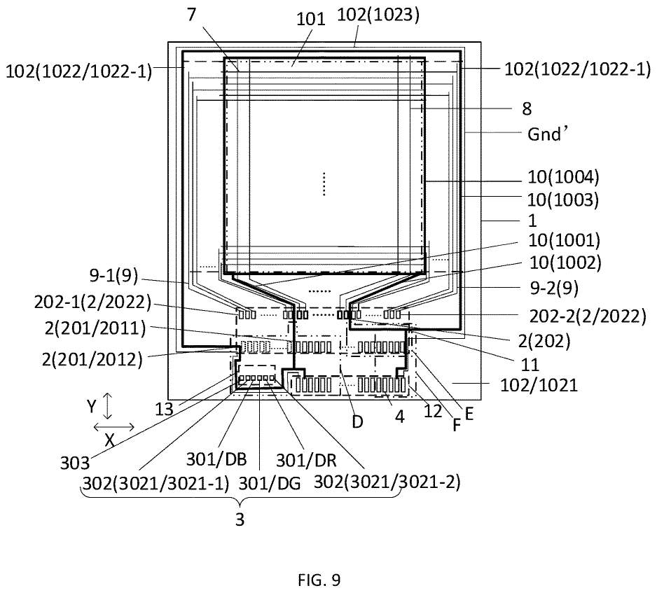

In some embodiments, as shown in FIG. 9, the display substrate further includes: a common electrode line 10 electrically connected to a common electrode (not shown).

In the first peripheral region 1021, the orthographic projection of the common electrode line 10 on the first base substrate 1 extends through the first bonding region 11 to the second bonding region 12, and the orthographic projection of the common electrode line 10 on the first base substrate 1 does not overlap with the orthographic projections of the first bonding terminals 2 on the first base substrate 1.

In some embodiments, the orthographic projection of the common electrode line on the first substrate and the orthographic projections of the transistors on the first substrate do not overlap each other.

In the display substrate provided by the embodiment of the present disclosure, the common electrode line passes through the first bonding region and extends to the second bonding region to be electrically connected to the second bonding terminal, so that the space of the first peripheral region can be reasonably utilized. In addition, the orthographic projection of the common electrode line on the first base substrate does not overlap with the orthographic projections the first bonding terminals and the orthographic projections of the transistors on the first base substrate, and interference of the common electrode line on the signal transmission of the first bonding terminals can also be avoided.

In some embodiments, as shown in FIG. 9, the common electrode line 10 includes a first common electrode line 1001 and a second common electrode line 1002.

In the first peripheral region 1021, the orthographic projection of the first common electrode line 1001 on first base substrate 1 is located on a side of the data lines 8 in a direction in which the second bonding terminals 4 point to the test terminals 3, and the orthographic projection of the second common electrode line 1002 on first base substrate 1 is located on the other side of the data lines 8 in the direction in which the second bonding terminals 4 point to the test terminals 3.

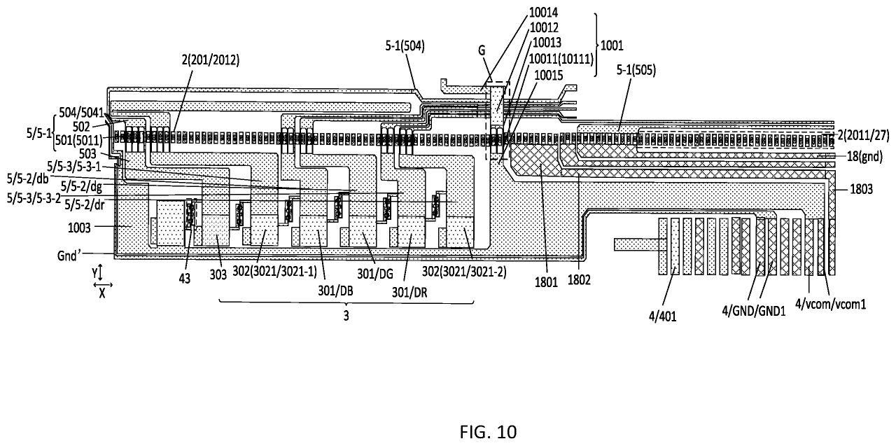

In some embodiments, as shown in FIG. 10, the first common electrode line 1001 includes a sixth portion 10011. The orthographic projection of the sixth portion 10011 on the first base substrate 1 overlaps with the orthographic projection of a region between adjacent first dummy terminals 2012 on the first base substrate 1, and the orthographic projection of the sixth portion 10011 on the first base substrate 1 is located between the orthographic projection of the first portion 501 of the test signal lines 5 on the first base substrate 1 and the orthographic projection of the first input terminals 2011 on the first base substrate 1.

It should be noted that FIG. 10 is a schematic diagram of an enlarged region D in FIG. 9.

In some embodiments, as shown in FIG. 9, the peripheral regions 102 further include a third peripheral region 1023 located on a side of the display region 101 facing away from the first peripheral region 1021. The common electrode line further includes a third common electrode line 1003, and a fourth common electrode line 1004. The fourth common electrode line 1004 surrounds the display region and is located on a side of the first connection lead 9 facing the display region 101, and the third common electrode line 1003 surrounds the display region 101 and is located on a side of the first connection lead 9 facing away from the display region 101. The third common electrode line 1003 is led out from one end of the plurality of second bonding terminals 4, passes through the second peripheral region 1022 on a side of the display region 101, the third peripheral region 1023, the second peripheral region 1022 on the other side of the display region 101, and then returns to the first peripheral region 1021 to be electrically connected to the other end of the plurality of second bonding terminals 4. The display substrate further includes a ground level lead Gnd′. The ground level lead Gnd′ is located on a side of the third common electrode line 1003 facing away from the display region 101.

In some embodiments, as shown in FIG. 10, the second bonding terminals 4 also include a plurality of common electrode bonding terminals vcom. One end of the first common electrode line 1001 and one end of the third common electrode line 1003 are electrically connected to the same common electrode bonding terminal vcom (i.e., the common electrode bonding terminal vcom marked as vcom1 in the figure). As shown in FIG. 13, end of the second common electrode line 1002 and the other end of the third common electrode line 1003 are electrically connected to the same common electrode bonding terminal vcom (i.e., the common electrode bonding terminal vcom marked as vcom2 in the figure).

In some embodiments, as shown in FIG. 10, a portion of the second dummy terminals 27 are arranged continuously on a side of at least a portion of the first input terminals 2011 facing away from the first dummy terminal 2012.

The second connection lead 18 electrically connected to the first input terminal 2011 located between the first dummy terminal 2012 and the second dummy terminal 27 includes: a fifteenth portion 1801 electrically connected to the first input terminal 2011 and extending along the first direction Y, a sixteenth portion 1802 electrically connected to the fifteenth portion 1801 and extending along the second direction X, and a seventeenth portion 1803 electrically connected to the sixteenth portion 1802 and the second bonding terminal 4.

It should be noted that, since the centers of the second bonding region and the first bonding region are located on different straight lines in the first direction, that is, the region bonded by the flexible circuit board is not directly opposite to the region bonded by the driving chip, the wiring space of the second connection lead electrically connected to the first input terminal and the second bonding terminal is also changed. In the display substrate provided by the embodiment of the present disclosure, when the wiring space is limited, at least part of the second connection leads are led out from the first input terminal located on a side of the plurality of second dummy terminals toward the first dummy terminals, and then electrically connected to the second bonding terminal through the fifteenth portion, the sixteenth portion, and the seventeenth portion, so that the length of the second connection leads can be increased while reasonably utilizing the wiring space, which is beneficial to reducing the impedance of the second connection leads. In specific implementation, the length and width of the fifteenth portion, the sixteenth portion, and the seventeenth portion can be set according to the number of the second connection leads and the actual wiring space.

It should be noted that first input terminals are still disposed on a side of a part of the continuously arranged second dummy terminals facing away from the first dummy terminals, that is, some of the plurality of second dummy terminals are continuously arranged between at least some adjacent first input terminals.

In some embodiments, as shown in FIG. 10, the second connection leads 18 may be electrically connected to one first input terminal 2011 or to a plurality of first input terminals 2011. The second connection lead 18 may be electrically connected to one second bonding terminal 4 or to a plurality of second bonding terminals 4.

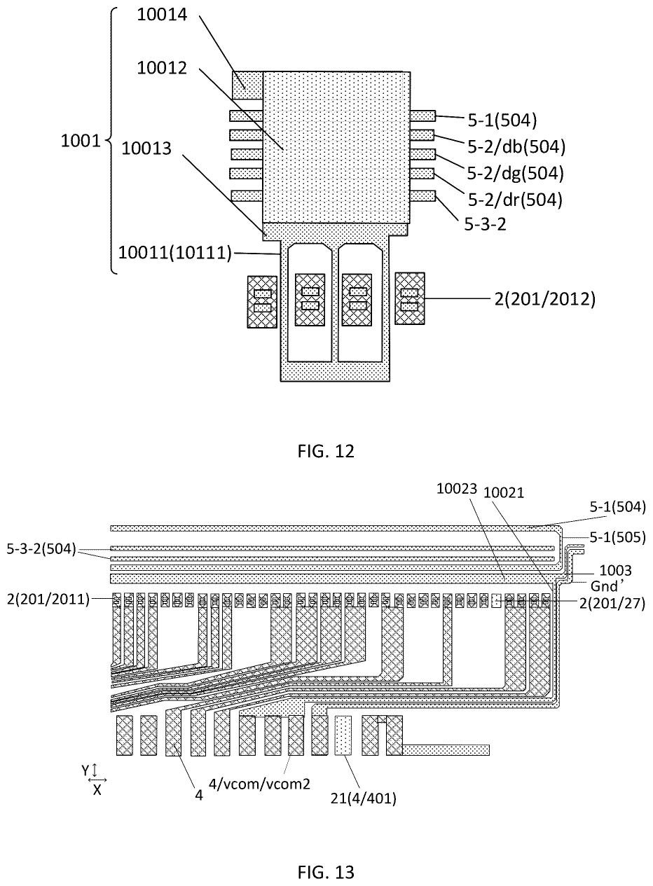

In some embodiments, as shown in FIG. 12, the sixth portion 10011 includes a plurality of first sub-common electrode lines 100111 arranged along the second direction X.

It should be noted that FIG. 12 is a schematic diagram of an enlarged region G in FIG. 10.

In the display substrate provided by the embodiment of the present disclosure, the sixth portion includes a plurality of first sub-common electrode lines, thereby improving the electrical connection performance between the sixth portion and the rest of the first common electrode lines, reducing the impedance of the first common electrode lines, and avoiding affecting signal transmission.

In some embodiments, as shown in FIG. 10 and FIG. 12, the first common electrode line 1001 further includes an eighth portion 10012 electrically connected to the sixth portion 10011 at a side of the sixth portion 10011 close to the display region 101.

The orthographic projection of the eighth portion 10012 on the first base substrate 1 overlaps with the orthographic projection of the fourth portion 504 of at least part of the test signal lines 5 on the first base substrate 1, and the eighth portion 10012 and the fourth portion 504 of at least part of the test signal lines 5 are located in different layers. Since the test signal line includes a portion extending along the second direction in the region corresponding to the transistor, the first common electrode line passing through the first bonding region will inevitably have an overlapping region with the portion of the test signal line extending along the second direction in the region corresponding to the transistor. In the overlapping region, the first common electrode line and the test signal line are located in different layers, which can avoid mutual interference between the first common electrode line and the test signal line.

In some embodiments, as shown in FIG. 10 and FIG. 12, the first common electrode line 1001 also includes: a tenth portion 10013 electrically connected to the sixth portion 10011 and the eighth portion 10012, and an eleventh portion 10014 electrically connected to the eighth portion 10012 at an end of the eighth portion 10012 facing away from the tenth portion 10013. The orthographic projection of the tenth portion 10013 on the first base substrate does not overlap with the orthographic projection of the test signal line 5 on the first base substrate, and the orthographic projection of the eleventh portion 10014 on the first base substrate does not overlap with the orthographic projection of the test signal line 5 on the first base substrate.

In a specific implementation, the eleventh portion is electrically connected to the fourth common electrode line through the region between the first group and the plurality of first transistors. The eighth portion is, for example, located in the third conductive layer or the fourth conductive layer, and the sixth portion, the tenth portion, and the eleventh portion are, for example, located in the first conductive layer. The eighth portion is electrically connected to the tenth portion and the eleventh portion through a via hole penetrating through each insulating layer between the third conductive layer and the first conductive layer, or the eighth portion is electrically connected to the tenth portion and the eleventh portion through a via hole penetrating through each insulating film layer between the fourth conductive layer and the first conductive layer.

In some embodiments, as shown in FIG. 10, the first common electrode line 1001 further includes: a twelfth portion 10015 located on a side of the sixth portion 10011 facing away from the display region. The twelfth portion 10015 is connected to the third common electrode line 1003.

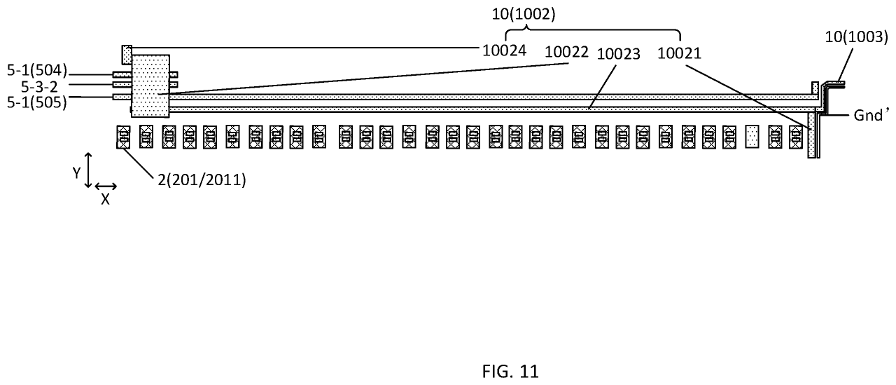

In some embodiments, as shown in FIG. 11, the second common electrode line 1002 includes a seventh portion 10021. In the second direction X, the orthographic projection of the seventh portion 10021 on the first base substrate 1 is located on a side of the orthographic projection of the first input terminals 2011 on the first base substrate 1 facing away from the orthographic projection of the first dummy terminals 2012 on the first base substrate 1.

It should be noted that FIG. 11 is a schematic diagram of an enlarged region F in FIG. 9.

In some embodiments, as shown in FIG. 11, the second common electrode line 1002 further includes a ninth portion 10022 electrically connected to the seventh portion 10021 at a side of the seventh portion 10021 close to the display region 101.

The orthographic projection of the ninth portion 10022 on the first base substrate 1 overlaps with the orthographic projection of the fourth portion 504 of at least part of the test signal lines 5 on the first base substrate 1, and the ninth portion 10022 and the fourth portion 504 of at least part of the test signal lines 5 are located in different layers.

In some embodiments, as shown in FIG. 11, the second common electrode line 1002 further includes: a thirteenth portion 10023 connecting the seventh portion 10021 and the ninth portion 10022, and a fourteenth portion 10024 located on a side of the ninth portion 10022 facing the display region. The thirteenth portion 10023 is connected to the third common electrode line 1003.

In some embodiments, as shown in FIG. 13, the seventh portion 10021 is electrically connected to the common electrode bonding terminal vcom (the common electrode bonding terminal vcom marked as vcom2 in the figure).

In the display substrate provided by the embodiment of the present disclosure, the orthographic projection of the seventh portion of the second common electrode line on the first base substrate is located on a side of the orthographic projection of the plurality of first input terminals on the first base substrate facing away from the orthographic projection of the plurality of first dummy terminals on the first base substrate, that is, the second common electrode line extends to the edge of the first bonding region, passes through the region between the input terminal and the edge of the first bonding region, and extends to the second bonding region, so that the wiring space can be reasonably utilized to realize the electrical connection between the second common electrode line and the third common electrode line, and realize the electrical connection between the second common electrode and the second bonding terminal.

In some embodiments, as shown in FIG. 9, in the first peripheral region 1021, the orthographic projection of the first common electrode line 1001 on the first base substrate 1 is located between the orthographic projection of the fifth group 9-1 on the first base substrate 1 and the orthographic projection of the data lines 8 on the first base substrate 1. The orthographic projection of the second common electrode line 1002 on the first base substrate 1 is located between the orthographic projection of the sixth group 9-2 on the first base substrate 1 and the orthographic projection of the data lines 8 on the first base substrate 1.

In some embodiments, as shown in FIG. 10, the display substrate further includes a plurality of first electrostatic units 43. The first electrostatic units 43 are electrically connected to the test terminals 3. A first electrostatic unit 43 is electrically connected between any two test terminals 3.

In some embodiments, as shown in FIG. 10, the first electrostatic unit 43 is also electrically connected to the third common electrode line 1003. The first electrostatic unit 43 is electrically connected between the third common electrode line 1003 and the test terminal 3. Thus, static electricity accumulation can be avoided.

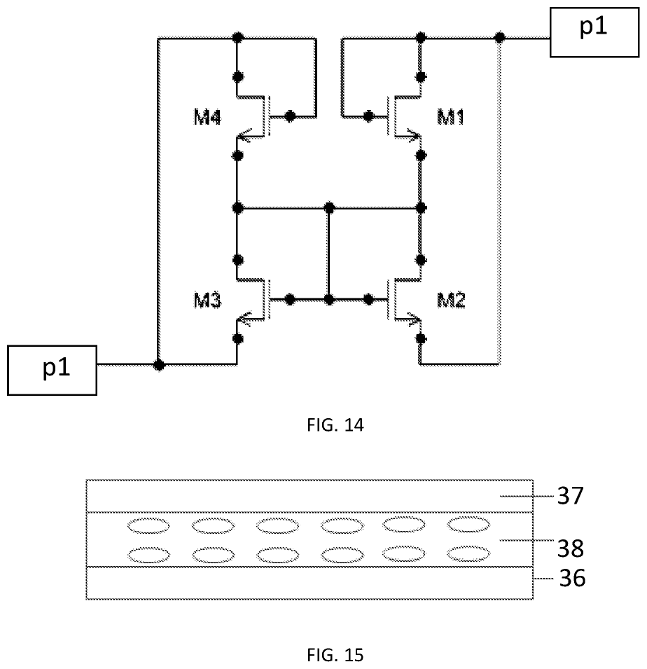

In some embodiments, the circuit diagram of the first electrostatic unit is shown in FIG. 14. The first electrostatic unit in FIG. 14 includes four thin film transistors, namely M1, M2, M3, and M4. p1 and p2 in FIG. 14 can both be test terminals. Of course, one of p1 and p2 can also be a test terminal and the other can be a common electrode layer.

In some embodiments, for various categories of signal lines such as test signal lines, common electrode lines, ground level leads, etc., if the extension direction changes, for example, from extending in the first direction to extending in the second direction, or from extending in the second direction to extending in the first direction, the edge of the pattern of the signal lines where the extension direction changes may include a portion extending in a third direction, and the third direction intersects both the first direction and the second direction. Taking the test signal line 3 as an example, as shown in FIG. 5, the angle of the contour where the extension direction of the test signal lines 3 in the J region and the K region changes is not a right angle. This can avoid the occurrence of tip discharge between adjacent signal lines.

Based on the same inventive concept, an embodiment of the present disclosure provides a display panel, as shown in FIG. 15, including a display substrate 36 provided in an embodiment of the present disclosure.

In some embodiments, as shown in FIG. 15, the display panel further includes:
an opposite substrate 37 arranged opposite to the display substrate 36;
a liquid crystal layer 38 located between the opposite substrate 37 and the display substrate 36.

In some embodiments, the opposite substrate includes a second base substrate, a black matrix and color filters on a side of the second base substrate facing the liquid crystal layer. The black matrix has opening regions. The opening regions correspond to the sub-pixel units of the display substrate one by one, and the color filters are located in the opening regions. A spacer is located on a side of the black matrix facing the liquid crystal layer. The color filters correspond to the sub-pixel units one by one. The sub-pixel units include red sub-pixels, blue sub-pixels, and green sub-pixels. Correspondingly, the color filters include red color filters corresponding to the red sub-pixels, blue color filters corresponding to the blue sub-pixels, and green color filters corresponding to the green sub-pixels.

A display device provided by an embodiment of the present disclosure includes the display panel provided by an embodiment of the present disclosure.

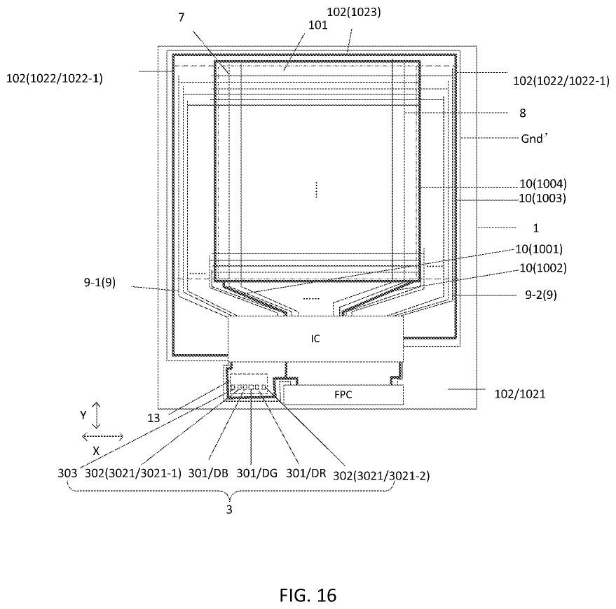

In some embodiments, in the above display device provided in the embodiment of the present disclosure, as shown in FIG. 16, it may further include:
a driving chip IC; the driving chip IC is bonded to a plurality of first bonding terminals (not shown) in a first bonding region (not shown);
a flexible circuit board FPC; the flexible circuit board FPC is bonded to a plurality of second bonding terminals (not shown) in a second bonding region (not shown).

In some embodiments, the display device provided in the embodiments of the present disclosure may further include a backlight module located on the light incident side of the display substrate. The backlight module may be a direct-lit backlight module or a side-entry backlight module.

In a specific implementation, the side-entry backlight module may include a light bar, a reflective sheet, a light guide plate, a diffuser, a prism group, etc., in stacks, and the light bar is located on a side of the thickness direction of the light guide plate. The direct-lit backlight module may include a matrix light source, a reflective sheet, a diffuser, and a brightness enhancement film stacked on the light-emitting side of the matrix light source. The reflective sheet includes an opening arranged directly opposite to the position of each lamp bead in the matrix light source. The lamp beads in the light bar and the lamp beads in the matrix light source can be light-emitting diodes (LEDs), such as micro light-emitting diodes (Mini LED, Micro LED, etc.). Submillimeter-level or even micron-level micro light-emitting diodes are self-luminous devices like organic light-emitting diodes (OLEDs). Like organic light-emitting diodes, it has a series of advantages such as high brightness, ultra-low latency, and ultra-large viewing angles. And because the light emission of inorganic light-emitting diodes is based on metal semiconductors with more stable properties and lower resistance, it has the advantages of lower power consumption, better resistance to high and low temperatures, and longer service life than organic light-emitting diodes that emit light based on organic matter. Moreover, when micro light-emitting diodes are used as backlight sources, more sophisticated dynamic backlight effects can be achieved. While effectively improving screen brightness and contrast, it can also solve the glare phenomenon caused by traditional dynamic backlighting between bright and dark areas of the screen, thereby optimizing the visual experience.

The display device provided in the embodiment of the present disclosure is any product or component with a display function, such as a mobile phone, a tablet computer, a television, a display, a laptop computer, a digital photo frame, a navigator, etc. Other essential components of the display device should be understood by a person skilled in the art, and will not be described in detail here, nor should they be used as a limitation of the present disclosure. The implementation of the display device can refer to the embodiment of the display panel above, and the repeated parts will not be described in detail.

To sum up, in the display substrate, display panel and display device provided by the embodiments of the present disclosure, the test terminal is arranged on a side facing away from the display region of the first bonding terminals bonded to the driving chip, thereby avoiding the test terminals being located on both sides of the first bonding terminals in the second direction intersecting the first direction, resulting in an increase in the width of the peripheral region in the second direction, thereby avoiding affecting the user experience.

Although the preferred embodiments of the present invention have been described, those skilled in the art may make other changes and modifications to these embodiments once they have learned the basic creative concept. Therefore, the appended claims are intended to be interpreted as including the preferred embodiments and all changes and modifications that fall within the scope of the present invention.

Obviously, those skilled in the art can make various changes and modifications to the present disclosure without departing from the spirit and scope of the present disclosure. Thus, if these modifications and variations of the present disclosure fall within the scope of the claims of the present disclosure and their equivalents, the present disclosure is also intended to include these modifications and variations.

1. A display substrate, comprising:
a first base substrate comprising a display region and a peripheral region surrounding the display region; wherein the peripheral region comprises a first peripheral region located at a side of the display region in a first direction;
a plurality of first bonding terminals located in the first peripheral region; wherein the plurality of first bonding terminals are configured to be bonded to a driving chip;
a plurality of test terminals located in the first peripheral region and on a side of the first base substrate same as a side where the plurality of first bonding terminals are located; wherein orthographic projections of the plurality of test terminals on the first base substrate are located on a side of orthographic projections of the plurality of first bonding terminals on the first base substrate facing away from the display region.

2. The display substrate according to claim 1, further comprising:
a plurality of second bonding terminals located in the first peripheral region and on a side of the first base substrate same as the side where the plurality of first bonding terminals are located; wherein the plurality of second bonding terminals are configured to be bonded to a flexible circuit board, and at least part of the second bonding terminals are electrically connected to at least part of the first bonding terminals; orthographic projections of the plurality of second bonding terminals on the first base substrate are located on a side of the orthographic projections of the plurality of first bonding terminals on the first base substrate facing away from the display region, and in a second direction, the orthographic projections of the plurality of test terminals on the first base substrate are located on a side of the orthographic projections of the plurality of second bonding terminals on the first base substrate, and the second direction intersects with the first direction.

3. The display substrate according to claim 2, wherein the plurality of first bonding terminals comprises:
a plurality of input terminals, wherein at least part of the plurality of input terminals are arranged along the second direction;
wherein the plurality of test terminals are located on a side of the plurality of input terminals facing away from the display region;
wherein the display substrate further comprises:
a plurality of test signal lines located in the first peripheral region; the plurality of test signal lines are electrically connected to the test terminals in an one-to-one manner; the test signal lines comprise a first portion, wherein an orthographic projection of the first portion on the first base substrate and orthographic projections of the input terminals on the first base substrate do not overlap with each other, and the orthographic projection of the first portion on the first base substrate overlaps with an orthographic projection of a region between adjacent input terminals on the first base substrate.

4. The display substrate according to claim 3, wherein the plurality of first bonding terminals further comprises:
a plurality of output terminals located on a side of the plurality of input terminals facing the display region; wherein the test signal lines are electrically connected to the output terminals.

5. The display substrate according to claim 4, wherein the plurality of input terminals comprise a plurality of first input terminals, and a plurality of first dummy terminals located on a side of the plurality of first input terminals in a direction in which the plurality of second bonding terminals point to the plurality of test terminals;
wherein the plurality of first input terminals are electrically connected to at least part of the second bonding terminals;
wherein the orthographic projection of the first portion on the first base substrate does not overlap with an orthographic projection of a region between adjacent first input terminals on the first base substrate, and the orthographic projection of the first portion on the first base substrate overlaps with an orthographic projection of a region between adjacent first dummy terminals on the first base substrate.

6. The display substrate according to claim 5, wherein the first portion comprises a plurality of first sub-signal lines arranged along the second direction; orthographic projections of the first sub-signal lines on the first base substrate overlap with the orthographic projection of the region between the adjacent first dummy terminals on the first base substrate.

7. The display substrate according to claim 6, wherein the test signal lines further comprise a second portion and a third portion which are respectively connected to two ends of the first portion in an extending direction of the first portion; wherein the second portion is located on a side of the first portion facing the display region, and the third portion is located on a side of the first portion facing away from the display region;
wherein in the second direction, a width of the first sub-signal lines is smaller than a width of a part of the second portion connected with the first portion, and the width of the first sub-signal lines is smaller than a width of a part of the third portion connected with the first portion.

8. The display substrate according to claim 7, wherein an edge of at least one of the first sub-signal lines extending in the first direction is located in a straight line same as a straight line where an edge of the second portion extending in the first direction is located, and the edge of at least one of the first sub-signal lines extending in the first direction is located in a straight line same as a straight line where an edge of the third portion extending in the first direction.

9. The display substrate according to claim 3, wherein the plurality of test terminals are arranged in sequence along the second direction;
wherein the first portion of the plurality of test signal lines is sequentially arranged along the second direction, the second portion of the plurality of test signal lines is sequentially arranged along the second direction, and the third portion of the plurality of test signal lines is sequentially arranged along the second direction.

10. The display substrate according to claim 9, further comprising:
a plurality of transistors located on a side of the first base substrate same as a side where the plurality of first bonding terminals are located in the first peripheral region; wherein orthographic projections of the plurality of transistors on the first base substrate are located between orthographic projections of a plurality of output terminals on the first base substrate and the orthographic projections of the plurality of input terminals on the first base substrate; each of the plurality of transistors comprises a control electrode, a first electrode and a second electrode; the plurality of transistors comprises: a plurality of first transistors, and a plurality of second transistors located on at least a side of the plurality of first transistors in the second direction;
wherein the plurality of output terminals comprise a plurality of first output terminals, and a plurality of second output terminals located on at least a side of the plurality of first output terminals in the second direction; first electrodes of the first transistors are electrically connected to the first output terminals, and first electrodes of the second transistors are electrically connected to the second output terminals;
wherein the plurality of test signal lines comprise a control signal line, a plurality of first signal lines, and at least one second signal line;
wherein the plurality of test terminals comprises a control terminal, a plurality of first test terminals, and a second test terminal;
wherein the control terminal is electrically connected to control electrodes of the plurality of transistors through the control signal line; the first test terminals are electrically connected to second electrodes of a part of the first transistors through the first signal lines; and the second test terminal is electrically connected to second electrodes of at least part of the second transistors through the at least one second signal line.

11. The display substrate according to claim 10, wherein in the second direction, the control terminal is located on a side of remaining test terminals other than the control terminal facing away from the plurality of second bonding terminals.

12. The display substrate according to claim 11, wherein the second test terminal comprises at least one sub-test terminal; in the second direction, the at least one sub-test terminal is located between the first test terminals and the control terminal, or the at least one of the sub-test terminals is located on a side of the first test terminals facing away from the control terminal.

13. The display substrate according to claim 12, wherein the second test terminal comprises: a first category of second test terminal located between the plurality of first test terminals and the control terminal, and a second category of second test terminal located on a side of the plurality of first test terminals facing away from the control terminal;
wherein the plurality of second transistors are divided into a first group located on a side of the plurality of first transistors in a direction in which the plurality of first test terminals point to the first category of second test terminal, and a second group located on a side of the plurality of first transistors in a direction in which the plurality of first test terminals point to the second category of second test terminal;
wherein the plurality of second output terminals are divided into a third group located on a side of the plurality of first output terminals in the direction in which the plurality of first test terminals point to the first category of second test terminal, and a fourth group located on a side of the plurality of first output terminals in a direction in which the plurality of first test terminals point to the second category of second test terminal; the second output terminals in the third group are electrically connected to the second transistors in the first group, and the second output terminals in the fourth group are electrically connected to the second transistors in the second group;
wherein the first category of second test terminal is electrically connected to second electrodes of the first group through the at least one second signal line, and the second category of second test terminal is electrically connected to second electrodes of the second group through the at least one second signal line.

14. The display substrate according to claim 12 er 13, wherein the test signal lines further comprise a fourth portion electrically connected to the second portion;
wherein at least part of the fourth portion extends along the second direction, and an orthographic projection of the fourth portion on the first base substrate is located between the orthographic projections of the plurality of output terminals on the first base substrate and the orthographic projections of the plurality of input terminals on the first base substrate;
wherein a fourth portion of the control signal line is electrically connected to the control electrodes of the plurality of transistors, a fourth portion of the first signal lines is electrically connected to second electrodes of the first transistors, and a fourth portion of the at least one second signal line is electrically connected to second electrodes of the second transistors;
wherein the fourth portion of the first signal lines is located on a side of the fourth portion of the control signal line facing away from the display region, and the fourth portion of the at least one second signal line is located on the side of the fourth portion of the control signal line facing away from the display region.

15. The display substrate according to claim 14, wherein the second test terminal comprises: a first category of second test terminal and a second category of second test terminal;
wherein the at least one second signal line comprises: a first category of second signal line and a second category of second signal line;
wherein a fourth portion of the first category of second signal line electrically connected to the first category of second test terminal is located between the fourth portion of the control signal line and the fourth portion of the plurality of first signal lines, and a fourth portion of the second category of second signal line electrically connected to the second category of second test terminal is located on a side of the fourth portion of the plurality of first signal lines facing away from the fourth portion of the control signal line; or
wherein the control signal line further comprises a fifth portion, wherein the fifth portion is electrically connected to the fourth portion of the control signal line at an end of the fourth portion of the control signal line facing away from the second portion;
wherein the plurality of first input terminals comprise a first ground-level signal input terminal; and the fifth portion is electrically connected to the first ground-level signal input terminal.

16. (canceled)

17. The display substrate according to claim 10, wherein the peripheral region further comprises second peripheral regions respectively located on both sides of the display region in the second direction; wherein the display substrate further comprises:
a plurality of sub-pixel units located on a side of the first base substrate same as the side where the plurality of first bonding terminals are located in the display region; the plurality of sub-pixel units comprise a plurality of sub-pixel units with different light emission colors; a quantity of the first test signal lines is equal to a quantity of types of the sub-pixel units;
a plurality of scanning lines electrically connected to the plurality of sub-pixel units and extending from the display region to the second peripheral regions; wherein the plurality of scanning lines are arranged along the first direction and extend along the second direction;
a plurality of data lines electrically connected to the plurality of sub-pixel units and extending from the display region to the peripheral regions; wherein the plurality of data lines are arranged along the second direction and extend along the first direction; each of the plurality of data lines is electrically connected to the first output terminals; and
a plurality of first connection leads extending from the first peripheral region to the second peripheral regions; two ends of each of the plurality of first connection leads are electrically connected to the second output terminals and the scanning lines respectively.

18. The display substrate according to claim 17, further comprising: a common electrode, and a common electrode line electrically connected to the common electrode;
wherein the first peripheral region comprises a first bonding region and a second bonding region located on a side of the first bonding region facing away from the display region, the orthographic projections of the plurality of first bonding terminals on the first base substrate and the orthographic projections of the plurality of transistors on the first base substrate fall into the first bonding region, and the orthographic projections of the plurality of second bonding terminals on the first base substrate fall into the second bonding region;
wherein in the first peripheral region, an orthographic projection of the common electrode line on the first base substrate extends through the first bonding region to the second bonding region, and the orthographic projection of the common electrode line on the first base substrate does not overlap with the orthographic projections of the first bonding terminals on the first base substrate.

19. The display substrate according to claim 18, wherein the plurality of input terminals comprise a plurality of first dummy terminals and a plurality of first input terminals; wherein the common electrode line comprises a first common electrode line and a second common electrode line;
wherein in the first peripheral region, an orthographic projection of the first common electrode line on the first base substrate is located on a side of the plurality of data lines in a direction in which the plurality of second bonding terminals point to the plurality of test terminals, and an orthographic projection of the second common electrode line on the first base substrate is located on the other side of the plurality of data lines in a direction in which the plurality of second bonding terminals point to the plurality of test terminals;
wherein the first common electrode line comprises a sixth portion, an orthographic projection of the sixth portion on the first base substrate overlaps with an orthographic projection of a region between adjacent first dummy terminals on the first base substrate, and the orthographic projection of the sixth portion on the first base substrate is located between orthographic projections of first portions of the plurality of test signal lines on the first base substrate and the orthographic projections of the plurality of first input terminals on the base first substrate;
wherein the second common electrode line comprises a seventh portion, and in the second direction, an orthographic projection of the seventh portion on the first base substrate is located on a side of the orthographic projections of the plurality of first input terminals on the first base substrate facing away from orthographic projections of the plurality of first dummy terminals on the first base substrate.

20. The display substrate of claim 19, wherein the sixth portion comprises a plurality of first sub-common electrode lines arranged along the second direction.

21. The display substrate according to claim 19, wherein the first common electrode line further comprises an eighth portion electrically connected to the sixth portion at a side of the sixth portion close to the display region;
wherein an orthographic projection of the eighth portion on the first base substrate overlaps with orthographic projections of fourth portions of at least part of the test signal lines on the first base substrate, and the eighth portion and the fourth portions of the at least part of the test signal line are located in different layers;
wherein the second common electrode line further comprises a ninth portion electrically connected to the seventh portion at a side of the seventh portion close to the display region;
wherein an orthographic projection of the ninth portion on the first base substrate overlaps with the orthographic projections of the fourth portions of the at least part of the test signal lines on the first base substrate, and the ninth portion and the fourth portions of the at least part of the test signal lines are located in different layers; or
wherein the plurality of second output terminals comprise a third group and a fourth group;
wherein the plurality of first connection leads are divided into a fifth group and a sixth group which extend to different second peripheral regions; first connection leads in the fifth group are electrically connected to second output terminals in the third group, and first connection leads in the sixth group are electrically connected to second output terminals in the fourth group;
wherein in the first peripheral region, the orthographic projection of the first common electrode line on the first base substrate is located between an orthographic projection of the fifth group on the first base substrate and orthographic projections of the data lines on the first base substrate, and the orthographic projection of the second common electrode line on the first base substrate is located between an orthographic projection of the sixth group on the first base substrate and the orthographic projection of the data lines on the first base substrate.

22-26. (canceled)
